(19) United States
(12) Patent Application Publication
(10) Pub. No.: US 2016/0358282 A1
(43) Pub. Date: Dec. 8, 2016

(54) COMPUTERIZED SYSTEM AND METHOD FOR REDUCING HOSPITAL READMISSIONS

(71) Applicants: Vipin Gopal, Louisville, KY (US); Guoxin Tang, Louisville, KY (US); Hamed Zahedi, Louisville, KY (US); Yan Zhang, Louisville, KY (US)

(72) Inventors: Vipin Gopal, Louisville, KY (US); Guoxin Tang, Louisville, KY (US); Hamed Zahedi, Louisville, KY (US); Yan Zhang, Louisville, KY (US)

(73) Assignee: HUMANA INC., Louisville, KY (US)

(21) Appl. No.: 13/036,528

(22) Filed: Feb. 28, 2011

Related U.S. Application Data
(60) Provisional application No. 61/428,101, filed on Dec. 29, 2010.

(51) Int. Cl. G06Q 50/00

(52) U.S. Cl. CPC G06Q 50/22

(57) ABSTRACT

A computerized system and method comprises a predictive model for estimating the probability of a patient hospital readmission. The computerized system and method is useful for identifying patients at risk of hospital readmission and further identifying an intervention to mitigate the risk and reduce the likelihood that the patient returns to the hospital. The computerized system method collects and analyzes historical health data from administrative claims data and current health data collected in real-time from medical records at the point of treatment. Signals indicating readmission are extracted from the health data that is collected. The signals are evaluated by the model software application to estimate a probability that a patient will be readmitted to the hospital. Patients with a high readmissions probability score are selected for clinical programs and interventions that help them manage their health conditions and problems and reduce the likelihood that they return to the hospital.

### CROSS-REFERENCE TO RELATED APPLICATIONS

This application claims priority to US Provisional Patent Application Ser. No. 61/428,101, filed Dec. 29, 2010, titled COMPUTERIZED SYSTEM AND METHOD FOR REDUCING HOSPITAL READMISSIONS, the content of which is incorporated herein by reference.

### BACKGROUND OF THE INVENTION

Unplanned and preventable hospital readmissions (also called rehospitalizations) represent an increasing share of healthcare costs. In response to the rising cost, a number of healthcare providers and payors have undertaken studies to determine more accurate estimates of the cost. One health benefits provider, Humana Inc., recently estimated its total cost for hospital readmissions in 2009 at over $600M. The 2009 average allowed cost per readmission for the health benefits provider was further estimated to be $10,328. Other studies estimate aggregate total annual costs for readmissions/rehospitalizations to be tens of billions of dollars.

At least one study estimates that three-quarters of Medicare patient readmissions could likely be avoided with better care¹, thereby resulting in substantial savings. Even a small decline in hospital readmission rates can result in a substantial healthcare cost savings. Reducing admissions, however, requires an understanding of why they occur and who is at risk. Current efforts directed toward reducing readmissions include collecting data at the point of treatment and applying empirical clinical rule sets to identify patients at risk for readmission. The rule sets are typically developed by clinical personnel and reflect their judgment of risk factors associated with readmission. Although a rule-based approach facilitates the process of identifying at risk patients, it is, unfortunately, fairly inaccurate. The rules are based primarily on personal judgment from clinical personnel and therefore, subjective. Different clinicians reach different conclusions when presented with the same set of clinical facts. In addition, the rules-based model does not support good risk stratification. The outcome of the process is the identification of a patient that is “at risk” or “not at risk.” The outcome reflects the presence of a risk rather than the quantification of a risk. Finally, because the rules are developed and applied by clinical personnel, only a limited number of factors or data elements can practicably be considered in each case. ¹ Report to the Congress: Promoting Greater Efficiency in Medicare, Medicare Payment Advisory Commission, Jun. 2007: 111-114.

Reducing readmissions and rehospitalizations requires not only identifying contributory risk factors to identify at-risk patients, but also providing patients with information and/or directing them to interventions or programs that focus on mitigating the contributory factors. The identification and mitigation of risk factors not only assists healthcare providers and payors in reducing costs but also contributes to patient well-being and better outcomes. By addressing the contributory risk factors after hospitalization, patients focus on improving various aspects of their health conditions and may avoid subsequent admissions to the hospital.

Patients, as well as healthcare providers and payors, benefit from a reduction in hospital readmissions. The identification of risk factors allows providers, payors, and patients to apply resources in a manner that reduces the likelihood a patient will return to the hospital. There is a need for a system and method that accurately and objectively identifies patients at risk for hospital readmission. There is a need for a system and method that identifies the patients with a high probability of readmission and further, directs them to the appropriate clinical intervention or program or provides them with information and other assistance to help them avoid further hospitalizations. There is a need for a system and method that benefits patients, healthcare providers, and healthcare payors by reducing hospital readmissions.

### SUMMARY OF THE INVENTION

A computerized system and method according to the present disclosure comprises a predictive model for estimating the probability of a patient's hospital readmission. In an example embodiment, the computerized system and method estimates the probability of readmission within 30 days for each initial admission. The computerized system and method is useful for identifying patients at risk of hospital readmission and further identifying an intervention to mitigate the risk and reduce the likelihood that the patient returns to the hospital. The identification of risk factors may be used to drive patients to the appropriate intervention, at an appropriate time, and in an appropriate way.

The computerized system and method may be used by a healthcare payor such as a health benefits provider. A predictive model is developed and integrated in a model software application that receives patient data as input and predicts for the patient the likelihood of a readmission or rehospitalization. The computerized system method collects and analyzes: (a) historical health data from administrative claims data; and (b) current health data collected in real-time from medical records at the point of treatment. Signals indicating readmission are extracted from the health data that is collected. The signals are evaluated by the model software application to estimate a probability that a patient will be readmitted to the hospital within a particular period of time (e.g., 30 days).

Patients with a high readmissions probability or risk score are selected for clinical programs and interventions that help them manage their health conditions and problems and reduce the likelihood of returning to the hospital. The clinical programs and interventions may include educating patients about their health conditions and providing specific recommendations related to monitoring their health status, medications, follow-up visits with healthcare providers, preventive and maintenance care, etc. Patient compliance with intervention efforts may be monitored to identify those patients that are at greatest risk for rehospitalization.

### BRIEF DESCRIPTION OF THE DRAWINGS

FIG. 1 is a block diagram illustrating development and application of a hospital readmission predictive model and model application according to an example embodiment;

FIG. 2 is a diagrammatic representation of data complexities for a hospital readmissions predictive model according to an example embodiment;

FIG. 3 is a block diagram illustrating development details of a predictive model according to an example embodiment;

FIG. 4 is a diagram of variables considered and associated probability of readmission according to an example embodiment;

FIG. 5 is a comparison of actual to predicted readmission rates according to an example embodiment; and

FIGS. 6A and 6B are block diagrams of a readmissions predictive model system according to example embodiments.

### DETAILED DESCRIPTION

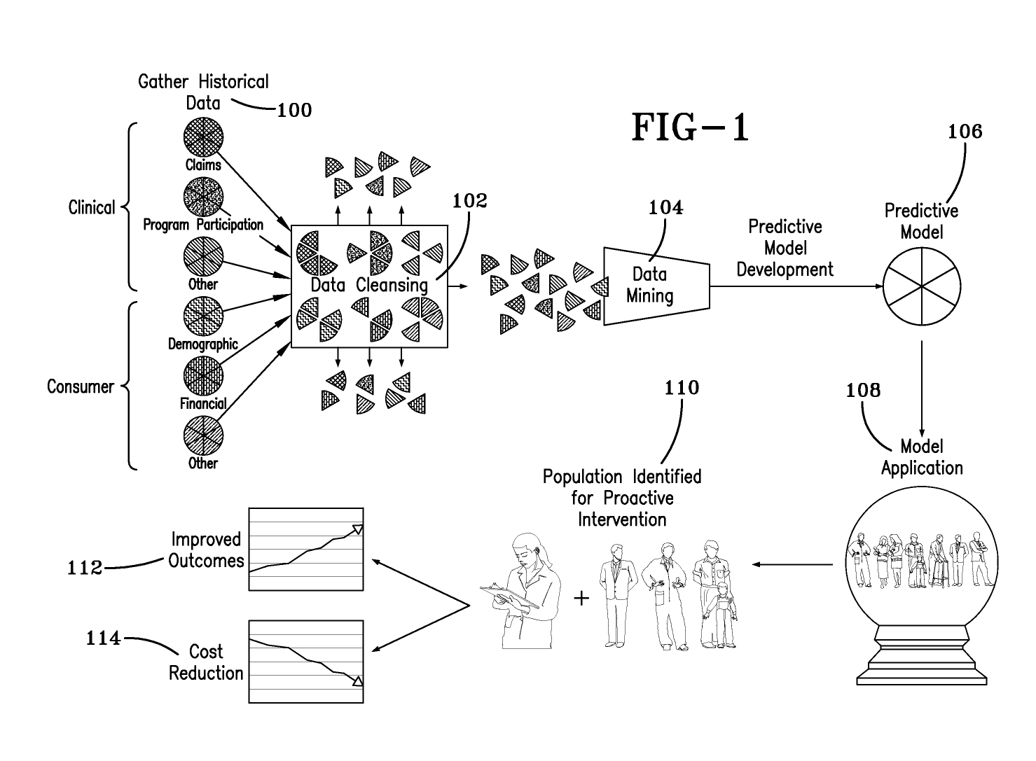

In an example embodiment a predictive model for hospital readmissions is integrated in a model software application for use by a health benefits provider with a covered patient-member population. Referring to FIG. 1, a block diagram illustrating development and application of a hospital readmission predictive model and model application according to an example embodiment is shown. Historical clinical data such as administrative claims data for medical and/or pharmacy claims and clinical/health program participation data as well as consumer data such as contact data, demographic data, and financial data 100 is input to a predictive model. The data may be cleansed 102 and mined 104 according to various well-known techniques. A hospital readmission predictive model 106 is developed using various well-known techniques as listed in Table 1.

TABLE 1
Predictive Model Techniques

| Modeling | |
|---|---|
| Technique | Description |
| Decision | Mapping of observations based on decisions to predict |
| Tree | value of a variable. |
| Regression | Estimates linear dependence of one or more independent |
| | variables on a dependent variable. |
| Neural | Nonlinear technique for modeling complex functions. |
| Networks | |
| Ensemble | Combination of multiple models for consensus prediction. |

The predictive model is then incorporated into a model application 108 that is applied to a member population. Members of the population that are at risk for readmission are selected for proactive clinical interventions and programs 110. The use of the model with proactive clinical programs and interventions helps to improve outcomes for members 112 and to reduce hospital-related costs for the health benefits provider 114.

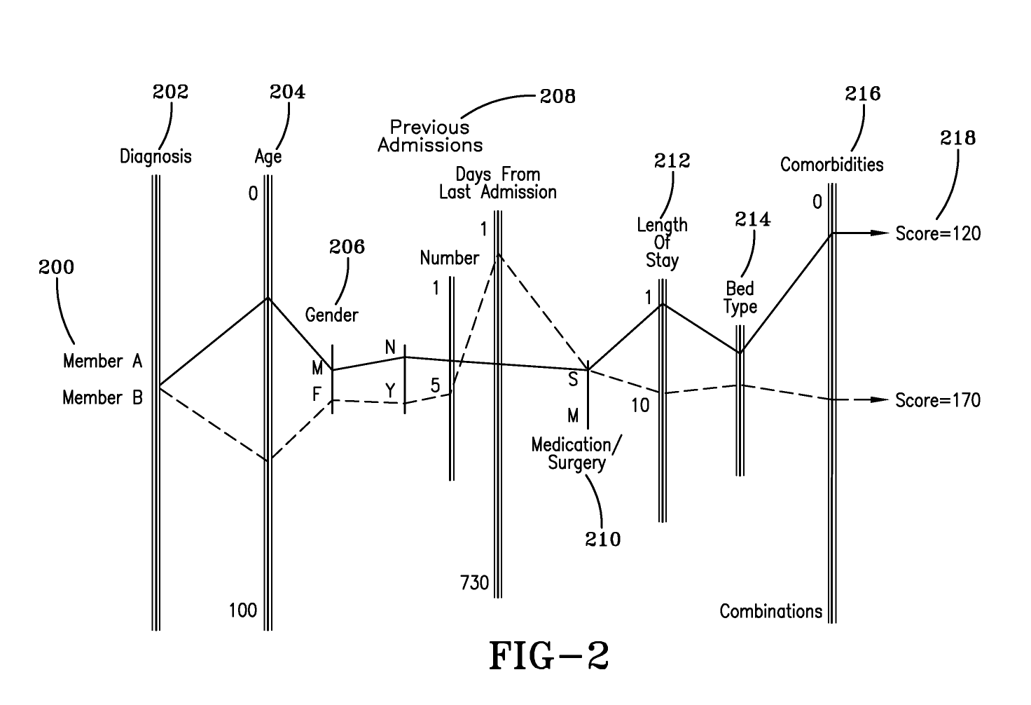

Referring to FIG. 2, a diagrammatic representation of data complexities for a hospital readmissions predictive model according to an example embodiment is shown. As indicated in FIG. 2, various factors may increase the likelihood that a member 200 is readmitted or rehospitalized. The likelihood of readmission may be expressed as a score 218 assigned to a member in relation to various factors such as: clinical diagnosis 202; age 204; gender 206; previous admissions 208 (e.g., any prior admissions, number of previous admissions, days since last admission); medications and surgery 210; length of stay 212; bed type 214; and comorbidities 216. Although many factors may contribute to a patient's readmission, some factors may be better “predictors” than others and therefore, incorporated into the model application applied to the member population.

FIG. 2 further illustrates the elements of administrative claims data and current treatment data that may be relevant to a patient's readmission score. For example, diagnosis 202, age 204, gender 206, number of previous admissions 208, days from last admission 208, and comorbidity 216 data may be discerned from member profile and administrative claims data while medication/surgery 210, length of stay 212, and bed type 214 may be discerned from a current medical record or treatment data. One of skill in the art would recognize that relevant input may be obtained from various databases and sources and may be provided to a readmissions predictive model as described herein.

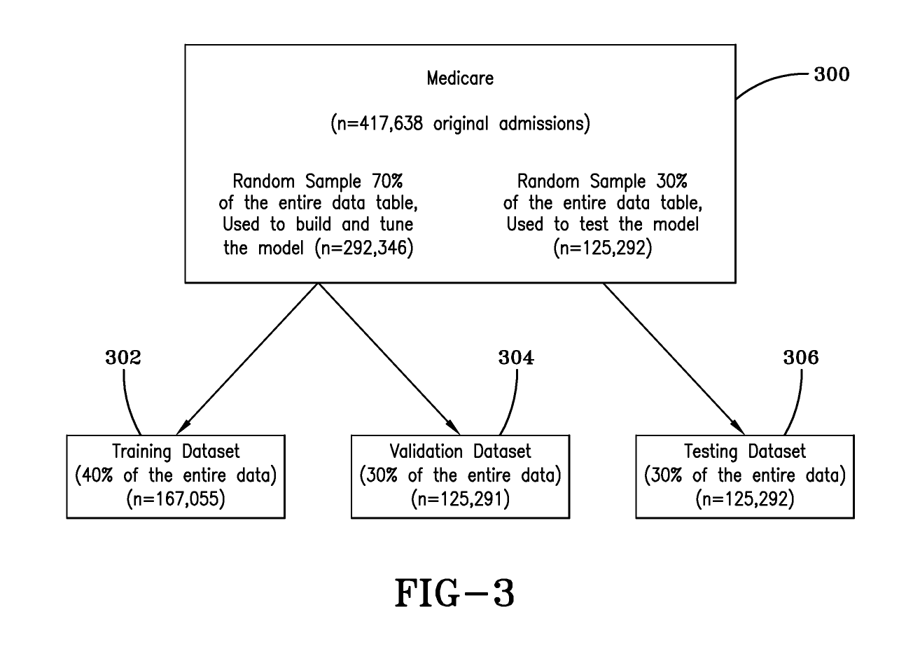

Referring to FIG. 3, a block diagram illustrating development details of a predictive model according to an example embodiment is shown. As illustrated in FIG. 3, membership and medical/pharmacy claims data for a covered population may be used as input to a predictive modeling system. The use of claims data provides the predictive modeling system with multiple years of data experience for millions of lives. Additionally, the input data may comprise medical records and other related demographic and financial data for the covered population. In the example shown, Medicare claims data for members discharged from a hospital and returned to a home or home healthcare setting is analyzed. One record for each initial admission may be analyzed. The model generates data of hospital readmissions and a variety of potential signals of readmissions from the database.

In the example shown, 417,638 original admissions were considered 300. A random sample of 70% of the entire data table was used to build and tune the model and 30% of the data table was used to test the model. For the Medicare population, 40% of all initial admissions were randomly assigned to the training dataset 302 and 30% to the validating (tuning) dataset 304. The model was built on the training dataset and subsequently validated. The model was then executed on the remaining 30% of the data (testing dataset 306) to assess the model's performance.

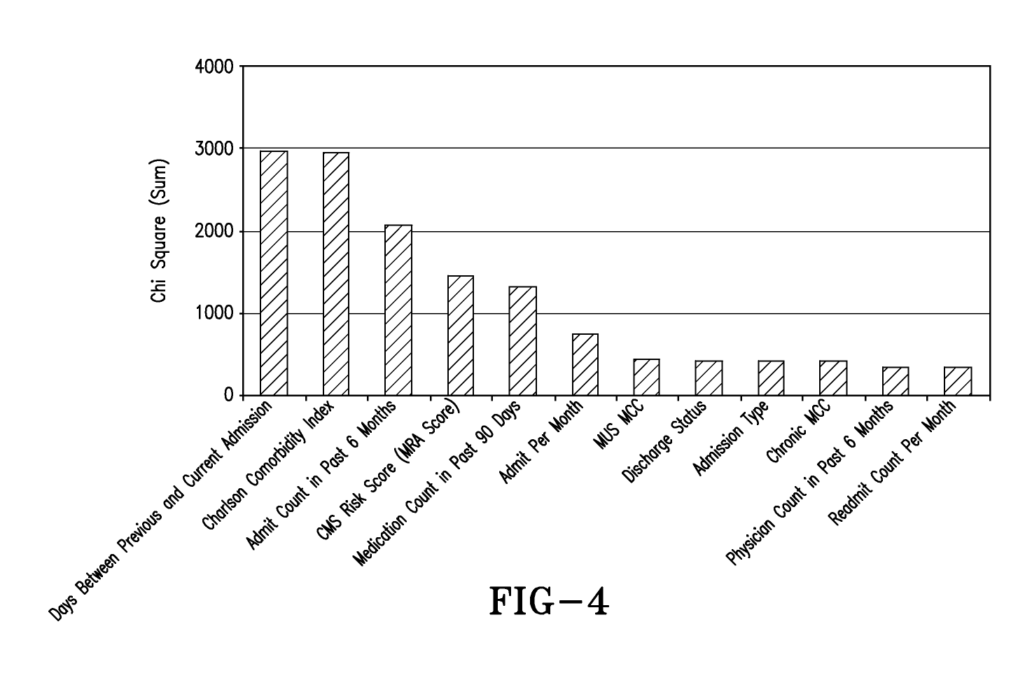

The predictive modeling system identifies and captures statistical relationships between potential signals and readmissions. Referring to FIG. 4, a diagram of variables considered and associated probability of readmission according to an example embodiment are shown. The Chi Square value shown in FIG. 4 is a statistical measure representing the relationship between the variables. As shown in FIG. 4, the three strongest predictors of a hospital readmission are “days between previous and current admission,” the Charlson Comorbidity Index, and “admission count in past six months.” Details of the numbers associated with the top three predictors are shown in Tables 2, 3, and 4.

TABLE 2
Days Between Previous and Current Admissions

| Days | Total | Readmission | Readmit Rate |
|---|---|---|---|
| 0-30 | 63,338 | 19,156 | 28.03% |
| 31-60 | 26,365 | 6,380 | 24.20% |
| 61-90 | 17,458 | 3,655 | 20.94% |
| 91-180 | 31,781 | 5,799 | 18.25% |
| 181-365 | 29,991 | 4,681 | 15.61% |
| No Previous Admit | 243,705 | 27,784 | 11.40% |
| Total | 417,638 | 67,455 | 16.15% |

TABLE 3
Charlson Comorbidity Index

| Comorbidity Rate | Total | Readmission | Readmit Rate |
|---|---|---|---|
| 0-5 | 252,811 | 28,913 | 11.44% |
| 6-10 | 134,474 | 28,783 | 21.40% |
| 11-15 | 26,892 | 8,419 | 31.31% |
| 16+ | 3,461 | 1,340 | 38.72% |
| Total | 417,638 | 67,455 | 16.15% |

TABLE 4
Admit Count in Past Six Months

| Admit Count | Total | Readmission | Readmit Rate |
|---|---|---|---|
| 0 | 272,216 | 32,315 | 11.87% |
| 1 | 89,136 | 16,946 | 19.01% |
| 2 | 32,149 | 8,646 | 26.89% |
| 3 | 13,266 | 4,517 | 34.05% |
| 4 | 5,807 | 2,353 | 40.52% |
| 5 | 2,697 | 1,279 | 47.64% |
| 6+ | 2,367 | 1,399 | 59.10% |
| Total | 417,638 | 67,455 | 16.15% |

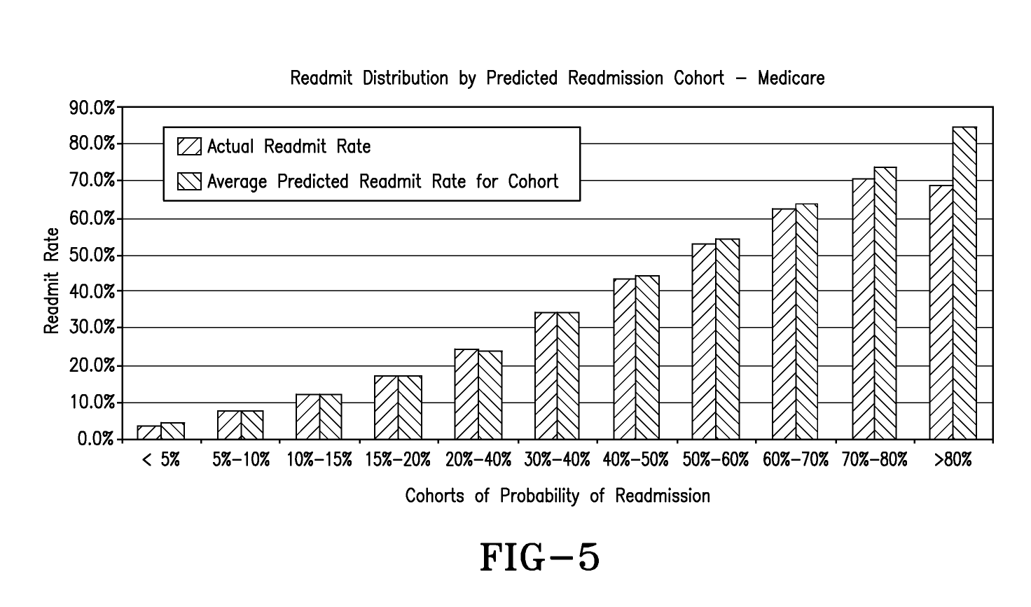

Referring to FIG. 5, a comparison of actual to predicted readmission rates according to an example embodiment is shown. FIG. 5 illustrates the performance of the predictive model by comparison with actual rates and indicates a strong correlation between the predictive rates and actual rates.

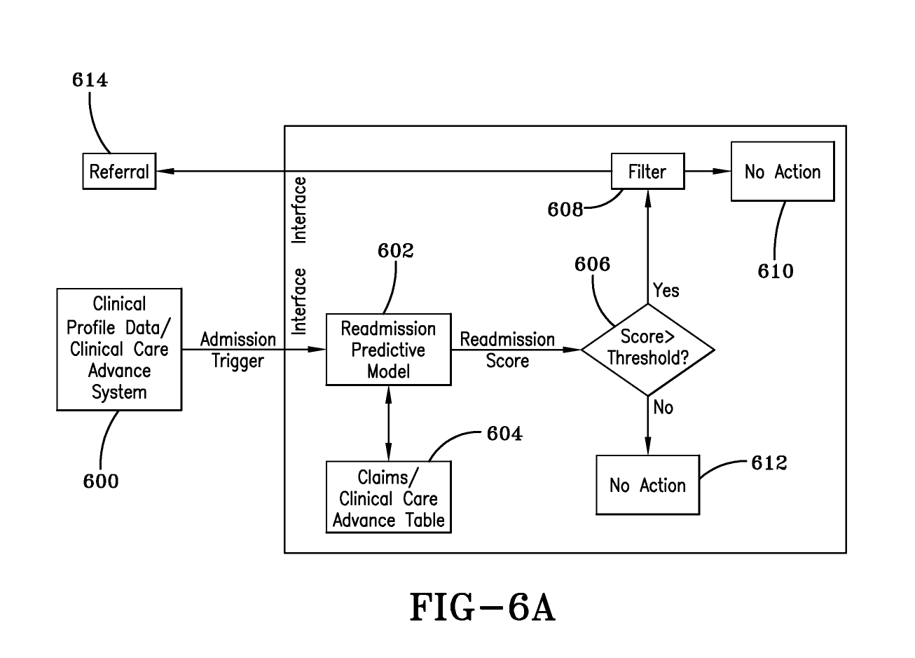

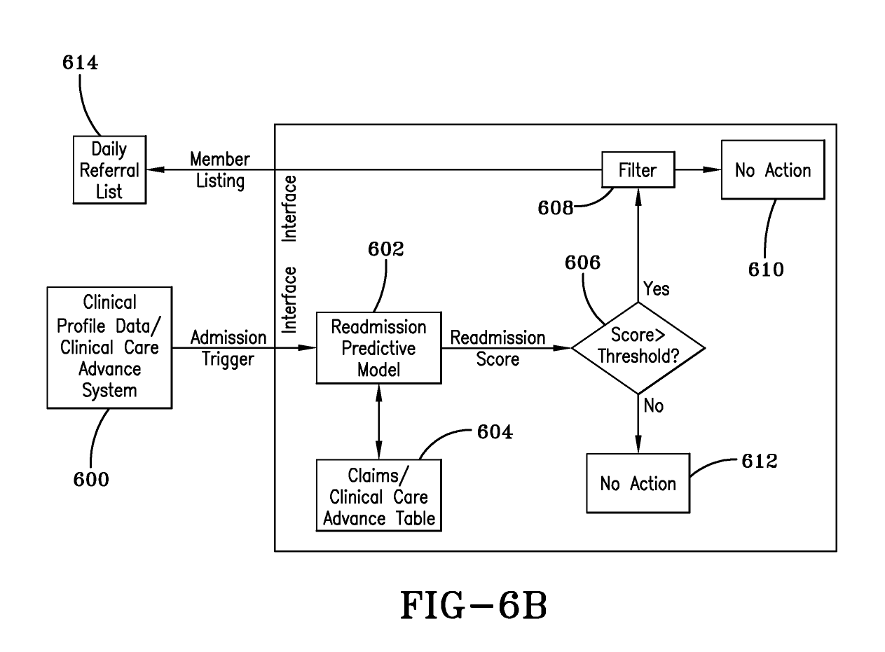

Referring to FIG. 6A, a block diagram of a readmissions predictive model system according to an online example embodiment for a health benefits provider is shown. The readmissions predictive model 602 may be integrated in a model software application used in real-time and applied to patient data on demand. In the “online” example embodiment, the model software application executes on a server and receives data from a clinical profile database and/or clinical care advance system 600 in response to a user request. The clinical profile database comprises a complete profile for a covered member including contact information, demographic profile data such as age and gender, claims data for medical and/or pharmacy claims submitted by the member to the health benefits provider, a contact history with details regarding communications between the member and the health benefits provider (e.g., mailings, telephone calls, emails, web site visits, and other outreach efforts), and participation data related to clinical programs and interventions in which the member has been enrolled and/or participated. A clinical care advance system may be used by nurses and clinical specialists to access the member's clinical profile and claims data and to assist them in providing services to members. Nurses, clinical specialists, and other representatives of the health benefits provider may interact with members to provide information about programs and interventions and other assistance related to the member's health conditions or problems.

An admission trigger from the clinical profile data and/or clinical care advance system database 600 may be used to invoke the readmission predictive model 602 and to estimate a readmission probability score for a member. In an example embodiment, the readmission predictive model is triggered by specified events during the admission stay in the hospital such as admission to the hospital, discharge from the hospital, or a major status change such as transfer to an intensive care unit. Data related to these events is entered in a clinical care advanced system database, and triggers the model to make predictions based on the most up-to-date information.

A customer care representative from the health benefits provider may interact with an online clinical care advance system 604 and may request a readmission score in connection with assisting the member while using the clinical care advance system 604. The clinical care advance system allows a representative to access the member's profile data and see details that may assist the representative in providing information and services to the member.

The model 602 is applied to the member's clinical profile data 600, which is refreshed periodically, to generate a readmission score. The score may then be compared against a threshold value 606. Patients with scores above the threshold may be considered for further action 608 while patients with scores below the threshold are not considered for further action 612. One of skill in the art would recognize that the score threshold may be established in such a way that a certain percentage of the covered population (e.g., 20%) is selected for further action. One of skill in the art would also recognize that score ranges (e.g., 0-100, 101-250, 251+) may be established, each of which is associated with a different intervention action. In some instances, no additional action or limited action may be taken (e.g., a phone call) as the readmission score is within an acceptable or low risk range. The scores may be used in a variety of ways to determine whether certain members are directed to additional programs and interventions.

Members with scores that exceed a threshold 606 may be considered for additional clinical programs or interventions. Additional filters 608 may be applied to the member's profile data to identify appropriate clinical programs or interventions. The programs and/or interventions may be selected based on the member's health conditions or problems. Members that have been diagnosed with certain diseases or conditions (e.g., asthma, coronary artery disease, depression, diabetes) may be enrolled in a disease management program. Other programs may not be directed to a specific disease or condition but may be available to members to help them with various issues or concerns as they arise (e.g., nurse services, chronic care management, pharmacy counseling and education). Each program or intervention may have associated selection criteria 608 that are applied to member clinical data to determine whether a member is a candidate for a program or intervention. Example programs and interventions are identified in Table 5.

TABLE 5
Program Referrals

| Program | Description | Score |
|---|---|---|
| Personal Nurse | Phone-based service for members; specially- | 170 |
| (PN) | trained nurses provide health education | |
| | and counseling | |
| Senior | Service for senior members; case managers | 180 |
| Utilization and | work with members to assess needs and | |
| Case Management | develop goals | |
| Company Cares | Chronic care management program; service | 175 |
| | to coordinate care from multiple providers | |
| Communication | Service for all members; case managers work | 150 |
| Utilization and | with members to facilitate and increase | |
| Case Management | communication | |
| Prescription | Phone-based service for members; | 160 |
| Mentor | pharmacists provide medication safety | |
| | education and counseling | |
| Transplant | Service to assist members though evaluation, | 200 |
| | inpatient stay, and post-operative period | |

Readmission scores may also be used to develop a risk stratification strategy. In a risk stratification strategy, interventions are determined according to score ranges rather than individual scores.

TABLE 6
Risk Stratification

| Risk Stratification | Score Range | Interventions |
|---|---|---|
| Very high | >=200 | Nurse home visit |
| High | <200 and >=180 | Nurse call |
| Medium | <180 and >=160 | Non-clinical specialist call |
| Low | <160 | Automatic call |

Following application of filters or selection criteria, members with readmission scores that exceed a threshold may be referred to specific programs and/or interventions 614 that help them manage their health condition or problem and more importantly, help them to avoid a subsequent hospital visit or admission. For example, some members may receive instructions on taking prescribed medications and possibly avoid an adverse drug event that could result in a hospitalization. Other members may be assigned a personal nurse who answers the member's questions related to various areas of medical care. In many instances, the access to additional information and support related to the member's health condition or problem reduces the likelihood of another hospital admission.

Member participation in the recommended interventions or programs may be tracked in the member's clinical profile. For example, attendance at consultations for a disease management program may be recorded. Each member contact with the health benefits provider may be recorded. For example, participation data for members that are asked to periodically report health status indicators may be tracked. Members that do not report in when expected may be contacted by a representative of the health benefits provider.

Referring to FIG. 6B, a block diagram of a readmissions predictive model system according to an offline example embodiment for a health benefits provider is shown. The readmission predictive model 602 operates in the manner described in relation to FIG. 6A, but is applied to batched data rather than in response to an online request. In the offline embodiment, the clinical profile/clinical care advance system databases 600 and claims/clinical care advance table 604 may be updated daily through batch updates. The readmission predictive model 602 may be applied to member data to identify members at risk that will soon be discharged from the hospital. A threshold score comparison is made 606, program and/or intervention filter criteria are applied 608, and a daily referral list is generated 616. The referral list 616 is generated in connection with member hospital discharges so that, as appropriate, each member may be enrolled in or start participating in a program or intervention as soon as possible after leaving the hospital. Because many readmissions occur within a few weeks or days of a patient's discharge from the hospital, timely intervention is important in reducing the likelihood of a readmission. The daily referral list 616 allows the health benefits provider to identify members that are leaving the hospital, and high risk candidates for readmission. Appropriate programs and interventions may be defined at the time of discharge so that the likelihood of readmission is reduced.

The computerized system and method may be used by a healthcare payor such as a health benefits provider to identify the right members of a covered population for the right clinical interventions and programs, and the right time. The computerized system and method supports early, proactive intervention, and therefore, reduces costs and improves outcomes.

Models are built from large amount of historical and clinical data. The use of comprehensive data, including all relevant data elements and derived signals, provide higher prediction accuracy than prior art systems and methods. The statistical data patterns captured in the model provide objective and unbiased predictions. Furthermore, the model is suitable for risk stratification. The outcome is a number that is representative of a level of risk. The health benefits provider can then determine what actions to take based on each member's risk level.

While certain embodiments of the present invention are described in detail above, the scope of the invention is not to be considered limited by such disclosure, and modifications are possible without departing from the spirit of the invention as evidenced by the claims. For example, readmission thresholds and ranges as well as associated actions may be varied and fall within the scope of the claimed invention. Other aspects of the readmission predictive model may be varied and fall within the scope of the claimed invention. One skilled in the art would recognize that such modifications are possible without departing from the scope of the claimed invention.

1-7. (canceled)

8. A computerized system for reducing hospital admissions comprising:
(a) at least one computerized database storing for each of a plurality of inpatients patient data comprising:
(1) historical health data from administrative claims data for said inpatient;
(2) current health status data from at least one medical record for said inpatient;
(3) health condition data for one or more health conditions; and
(4) a plurality of readmission triggers to invoke application of a readmissions predictive model;
(b) a server executing programming instructions to:
(1) identify by said computer in said patient data at least one of said plurality of readmission triggers for a plurality of inpatients;
(2) apply by said server to said historical health data and said current health data said readmissions predictive model to calculate a readmission risk score for each of said plurality of inpatients, said readmissions predictive model evaluating at least one factor selected from the group consisting of: a number of days between previous and current admission, a Charlson Comorbidity Index, and an admission count within a specified period;
(3) compare by said server said readmission risk scores to a threshold score; and
(4) if said readmission risk score exceeds said threshold score, identify by said computer a subset of inpatients where wherein at least one clinician identifies for each of said inpatients:
(i) one or more health conditions for said inpatient; and
(ii) at least one intervention for said inpatient based on said one or more health conditions for said inpatient, said intervention comprising providing said inpatient with medication safety education and post-discharge counseling.

9. The computerized system of claim 8 wherein said intervention is enrolling said inpatient in a chronic care management program.

10-11. (canceled)

12. The computerized system of claim 8 wherein said server applies said readmission predictive model in response to an online request.

13. The computerized system of claim 8 wherein said server applies said readmission predictive model in connection with a batch of patient data.

14. The computerized system of claim 8 wherein said server further executes said programming instructions in response to a readmissions trigger selected from the group consisting of an admission to a hospital or a discharge from a hospital.

15. A computerized method for reducing hospital admissions comprising:
(a) receiving at a computer patient data for a plurality of inpatients to be discharged from an inpatient facility, said inpatients having one or more different health conditions, comprising:
(1) historical health data from administrative claims data for said each of said inpatients; and
(2) current health data from at least one medical record for each of said inpatients;
(b) defining at said computer a plurality of readmissions triggers to invoke application of a readmissions predictive model wherein said readmissions predictive model evaluates at least one factor selected from the group consisting of: a number of days between previous and current admission, a Charlson Comorbidity Index, and an admission count within a specified period;
(c) identifying by said computer in said patient data at least one of said plurality of readmission triggers for a subset of said plurality of inpatients having one or more different health conditions;
(d) applying by said computer to said patient data for each of said inpatients in said subset said readmissions predictive model;
(e) receiving at said computer from said readmissions predictive model a readmission risk score for each of said inpatients in said subset;
(f) comparing by said computer said readmission risk score for each of said inpatients in said subset to a threshold score; and
(g) for each inpatient with a readmission score exceeding said threshold score, adding by said computer said inpatient to a list of inpatients and associated readmissions scores for review by a computer user; and
(h) identifying for each patient on said list, an intervention that will reduce the risk score determined by said readmissions predictive model.

16. (canceled)

17. The computerized method of claim 15 further comprising identifying for each inpatient with a readmission risk score exceeding said threshold score an intervention.

18. (canceled)

19. The computerized method of claim 15 wherein receiving at a computer patient data comprises receiving said patient data in a batch of patient data.

20. (canceled)

21. The computerized method of claim 15 wherein said intervention comprises providing said inpatient with medication safety education and post-discharge counseling.
